(19) United States
(12) Patent Application Publication
(10) Pub. No.: US 2014/0101014 A1
(43) Pub. Date: Apr. 10, 2014

(54) DESIRED MONEY-AMOUNT MANAGEMENT APPARATUS, DESIRED MONEY-AMOUNT MANAGEMENT METHOD, AND NON-TRANSITORY COMPUTER-READABLE MEDIUM

(71) Applicant: PFU Limited, Kahoku-shi (JP)

(72) Inventors: Kayo IIMURO, Ishikawa (JP); Koichi KITAGAWA, Ishikawa (JP); Kyoji INARI, Ishikawa (JP)

(73) Assignee: PFU Limited, Kahoku-shi (JP)

(21) Appl. No.: 14/102,046

(22) Filed: Dec. 10, 2013

Related U.S. Application Data
(63) Continuation of application No. PCT/JP2011/063401, filed on Jun. 10, 2011.

(51) Int. Cl. G06Q 40/02

(52) U.S. Cl. CPC G06Q 40/02
USPC 705/35

(57) ABSTRACT

A desired money-amount management apparatus includes a control unit and a display unit. The control unit includes (i) a setting unit that sets a group goal for an amount of money for a group composed of a plurality of users registered in a household-accounts management application, (ii) a summing unit that sums remaining amounts, registered in the household-accounts management application, of all member users being the users constituting the group, (iii) a checking unit that checks a progress status of the group goal based on the group goal set by the setting unit and the remaining amount summed by the summing unit, and (iv) a progress-display executing unit that displays the progress status checked by the checking unit on the display unit.

### CROSS-REFERENCE TO RELATED APPLICATION

This application is based upon and claims the benefit of priority from PCT application PCT/JP2011/063401, filed Jun. 10, 2011, the entire contents of which are incorporated herein by reference.

### BACKGROUND OF THE INVENTION

1. Field of the Invention

The present invention relates to a desired money-amount management apparatus, a desired money-amount management method, and a non-transitory computer-readable medium for managing a goal for money (e.g., saving goal or savings goal) in management of a household accounts book.

2. Description of the Related Art

Management of a household accounts book in a family is primarily performed by each individual of the family such that the individual uses a household-accounts management application to individually manage his/her household accounts book or such that a representative of the family uses it to manage a household accounts book.

A citation list for the management of the household accounts book includes, for example, JP-A-11-59025 and JP-A-2003-76846. JP-A-11-59025 discloses a technology for a family budget management table in which expenses and balance of payments required for family budget management are managed in a single table. JP-A-2003-76846 discloses a technology for a family budget management support method and the like in which a user is prompted to enter family budget data to a display screen serving as an interface and rendered as a game, and in which the entered family budget data is transmitted to a family budget management server to register the family budget data transmitted to the family budget management server in a family budget database.

However, the management of the household accounts book so far has some problems such that a goal for money (e.g., saving goal or savings goal) cannot be managed in terms of an overall group such as a family.

### SUMMARY OF THE INVENTION

It is an object of the present invention to at least partially solve the problems in the conventional technology.

A desired money-amount management apparatus according to one aspect of the present invention includes a control unit and a display unit. The control unit includes (i) a setting unit that sets a group goal for an amount of money for a group composed of a plurality of users registered in a household-accounts management application, (ii) a summing unit that sums remaining amounts, registered in the household-accounts management application, of all member users being the users constituting the group, (iii) a checking unit that checks a progress status of the group goal based on the group goal set by the setting unit and the remaining amount summed by the summing unit, and (iv) a progress-display executing unit that displays the progress status checked by the checking unit on the display unit.

A desired money-amount management method according to one aspect of the present invention is executed by a desired money-amount management apparatus including a control unit and a display unit. The method executed by the control unit includes (i) a setting step of setting a group goal for an amount of money for a group composed of a plurality of users registered in a household-accounts management application, (ii) a summing step of summing remaining amounts, registered in the household-accounts management application, of all member users being the users constituting the group, (iii) a checking step of checking a progress status of the group goal based on the group goal set at the setting step and the remaining amount summed at the summing step, and (iv) a progress-display executing step of displaying the progress status checked at the checking step on the display unit.

A non-transitory computer-readable medium according to one aspect of the present invention includes programmed instructions for a desired money-amount management method executed by a desired money-amount management apparatus including a control unit and a display unit. The instructions, when executed by the control unit, cause the control unit to execute (i) a setting step of setting a group goal for an amount of money for a group composed of a plurality of users registered in a household-accounts management application, (ii) a summing step of summing remaining amounts, registered in the household-accounts management application, of all member users being the users constituting the group, (iii) a checking step of checking a progress status of the group goal based on the group goal set at the setting step and the remaining amount summed at the summing step, and (iv) a progress-display executing step of displaying the progress status checked at the checking step on the display unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an example of a configuration of a desired money-amount management apparatus;

FIG. 2 is a flowchart of an example of a desired money-amount management process executed by the desired money-amount management apparatus;

FIG. 3 is a diagram of an example of a household-accounts selection screen;

FIG. 4 is a diagram of an example of a household-accounts status screen; and

FIG. 5 is a diagram of an example of a goal progress screen.

### DETAILED DESCRIPTION OF THE PREFERRED EMBODIMENTS

Embodiments of a desired money-amount management apparatus, a desired money-amount management method, and a non-transitory computer-readable medium according to the present invention will be explained in detail below with reference to the accompanying drawings. It should be noted that the present invention is not limited by the present embodiments.

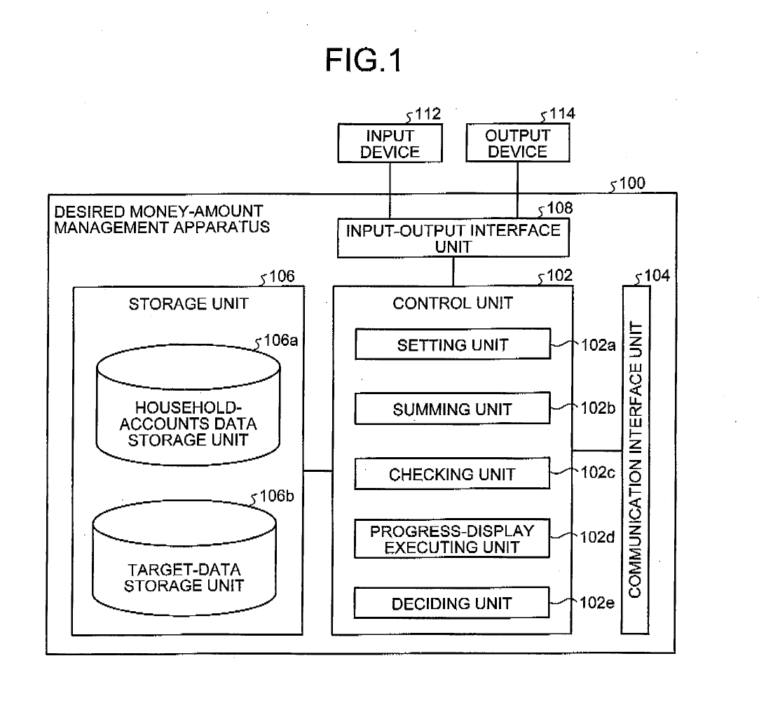

1. Configuration A configuration of the desired money-amount management apparatus according to the present embodiment will be explained with reference to FIG. 1. FIG. 1 is a block diagram of an example of the configuration of the desired money-amount management apparatus.

A desired money-amount management apparatus 100 is an information processing apparatus such as commercially available personal computer, smartphone, or tablet terminal, and includes a control unit 102, a communication interface unit 104, a storage unit 106, and an input-output interface unit 108. At least a household-accounts management application is installed on the desired money-amount management apparatus 100. Units included in the desired money-amount management apparatus 100 are communicably connected to one another via any communication channel.

The communication interface unit 104 communicably connects the desired money-amount management apparatus 100 to an external device or to a network via a communication device such as a router and a wired or a wireless communication line such as a dedicated line. The communication interface unit 104 has a function for communicating data with other devices via the communication line.

The input-output interface unit 108 is connected with an input device 112 and an output device 114. A speaker and a printer, in addition to a monitor (including a home television), can be used as the output device 114. In addition to a keyboard, a mouse, and a microphone, the monitor for implementing a pointing device function in cooperation with the mouse can be used as the input device 112. In the following, the output device 114 may be described as a monitor 114 and the input device 112 may be described as a keyboard 112 or a mouse 112.

The storage unit 106 includes a household-accounts data storage unit 106a and a target-data storage unit 106b. The storage unit 106 records therein a computer program and the like for giving instructions to a CPU (central processing unit) in cooperation with an OS (operating system) to perform various processes. As the storage unit 106, for example, a memory device such as RAM (random access memory) and ROM (read-only memory), a fixed disk drive such as a hard disk, a flexible disk, or an optical disc can be used.

The household-accounts data storage unit 106a stores therein household accounts data (including, e.g., Expense Item (Food or Miscellaneous, etc.), Actual Spending (Expenditure) corresponding to each expense item, Budget corresponding to each expense item, and Remaining Amount (Balance) corresponding to each expense item) for each user under the control of the household-accounts management application.

The target-data storage unit 106b stores therein a group goal for an amount of money (e.g., saving goal or savings goal including a purpose, a desired amount of money, and a goal achievement period (including savings start date and savings end date)) and a user goal for an amount of money (including, e.g., a shared amount of money or a sharing rate with respect to the desired amount of money). The group goal is set by a setting unit 102a, explained later, for a group (e.g., family or friends) composed of a plurality of users who manage their own household accounts books using the household-accounts management application. The user goal is set by the setting unit 102a, explained later, for each of member users (e.g., a family member or an individual friend) being the users constituting the group.

The control unit 102 includes a CPU and the like that integrally control the desired money-amount management apparatus 100. The control unit 102 has an internal memory to store therein a control program, programs defining various procedures or so, and necessary data, and performs information processing for executing various processes based on the programs. The control unit 102 includes the setting unit 102a, a summing unit 102b, a checking unit 102c, a progress-display executing unit 102d, and a deciding unit 102e.

The setting unit 102a sets the group goal for the group composed of the users who manage their own household accounts books using the household-accounts management application. The setting unit 102a may set the user goal for a member user included in the group.

The summing unit 102b sums remaining amounts (balances) of all the member users based on the household accounts data of all the member users included in the group.

The checking unit 102c checks a progress status of the group goal (e.g., degree of achievement or percent complete of the group goal) based on the group goal set by the setting unit 102a and the remaining amount summed by the summing unit 102b. The checking unit 102c may check a progress status of each user goal (e.g., degree of achievement or percent complete of the user goal) based on the user goal set by the setting unit 102a for each of the member users and the remaining amount included in the household accounts data for each member user.

The progress-display executing unit 102d displays the progress status checked by the checking unit 102c on the monitor 114. The progress-display executing unit 102d may display characters, for which emotional expressions (e.g., various emotions or mood states) decided by the deciding unit 102e are designed, on the monitor 114.

The deciding unit 102e decides an emotional expression of a character, for which the emotional expression is designed, based on the progress status checked by the checking unit 102c.

2. Processes

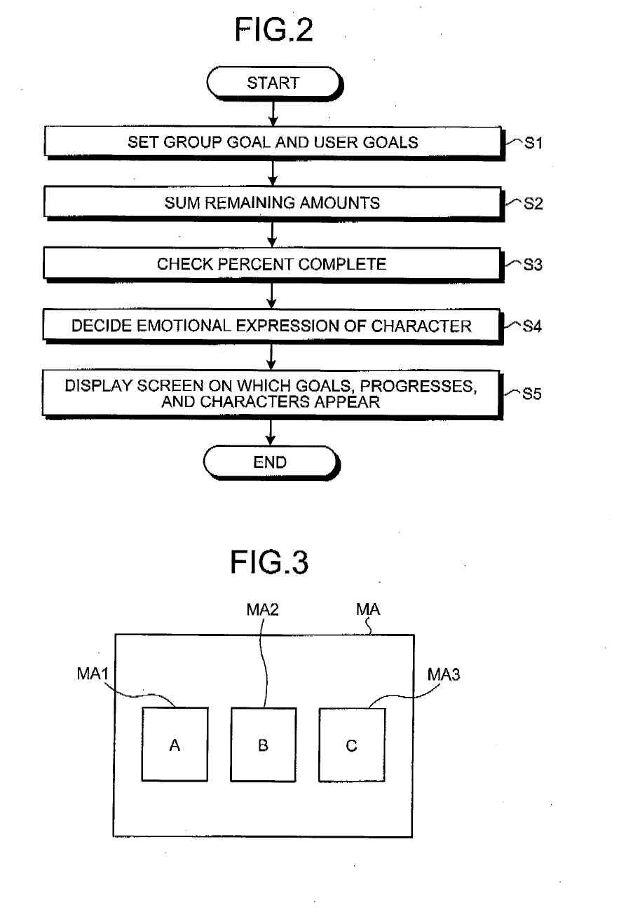

An example of a desired money-amount management process executed by the desired money-amount management apparatus 100 configured in the above manner will be explained below with reference to FIG. 2 to FIG. 5.

In a present explanation, it is assumed that three members: user A, user B, and user C use the household-accounts management application to manage household accounts books by each user itself, and household accounts data for the three members are stored in the household-accounts data storage unit 106a. In the present explanation, it is assumed that the three members are registered as member users who constitute one group. In addition, in the present explanation, the user A performs, for example, setting and checking of the group goal and the like.

The user A operates the input device 112 to select an area MA1 corresponding to the user A from among the area MA1, an area MA2, and an area MA3 provided on a household-accounts selection screen MA shown in FIG. 3 that the control unit 102 previously displays on the monitor 114.

The area MA1, the area MA2, and the area MA3 are provided to prompt a member user to select a display of his/her household accounts book. Specifically, the area MA1 is for selecting a display of the household accounts book of the user A, the area MA2 is for selecting a display of the household accounts book of the user B, and the area MA3 is for selecting a display of the household accounts book of the user C. However, the household-accounts selection screen MA is preferably designed so that even if a member user (e.g., user A) selects an area corresponding to one of the other member users (e.g., user B or user C), the household accounts book of the other member user is prevented from displaying.

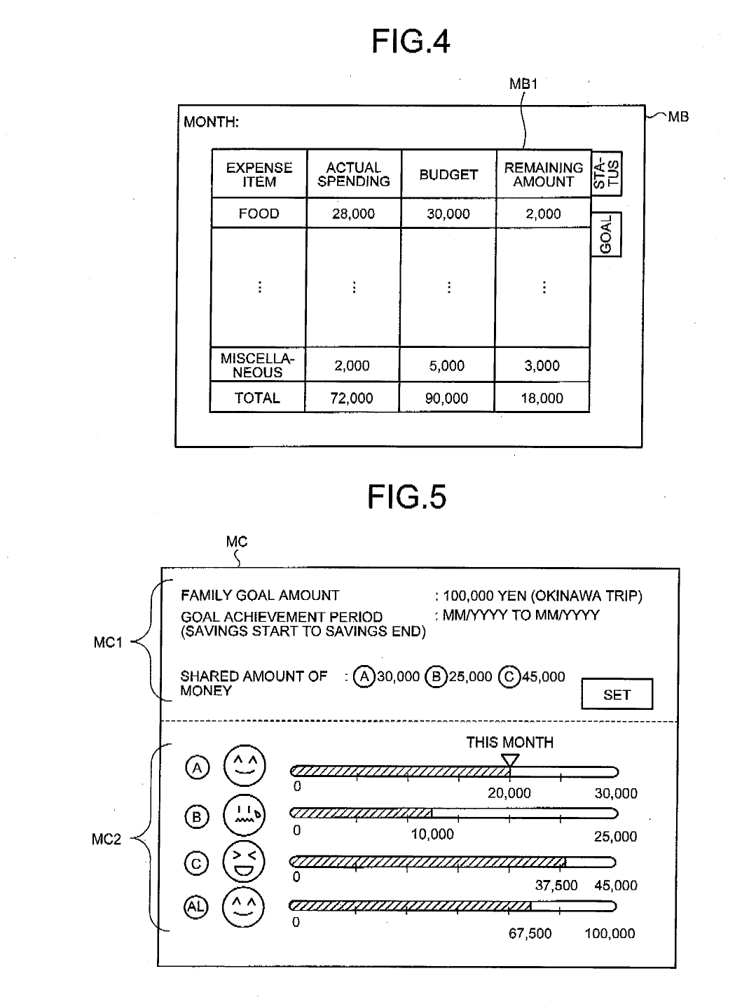

When any one of the areas provided on the household-accounts selection screen MA (the area MA1 shown in FIG. 3 in the present explanation) is selected, the control unit 102 reads the household accounts data for a member user (the user A in the present explanation) corresponding to the selected area from the household-accounts data storage unit 106a. The control unit 102 displays a household-accounts status screen MB shown in FIG. 4 on which the read household accounts data appears on the monitor 114.

The household-accounts status screen MB includes an area MB1 for displaying a present status of the household accounts book. The area MB1 includes a tag (status tag) on which a text “Status” is described and a tag (goal tag) on which a text “Goal” is described in order to select setting and checking of the group goal and the like. Displayed in the area MB1 are Expense Item, Actual Spending (Expenditure) corresponding to each Expense Item, Budget corresponding to each Expense Item, and Remaining amount (Balance) corresponding to each Expense Item, which are included in the read household accounts data, in a predetermined form (e.g., table).

The user A operates the input device 112 to select the goal tag included in the area MB1.

When the goal tag is selected, the control unit 102 checks whether the group goal of a group in which the user A is included as the member user and the user goals of the member users (the user A, the user B, and the user C in the present explanation) of the group are stored in the target-data storage unit 106b. When a check result is not “they are stored”, the control unit 102 activates the progress-display executing unit 102d, while when it is “they are stored”, the control unit 102 activates the summing unit 102b.

Step S1: Setting of Group Goal and User Goals

When the check result is not “they are stored”, the progress-display executing unit 102d generates a goal progress screen MC shown in FIG. 5 and displays the generated goal progress screen MC on the monitor 114.

The goal progress screen MC shown in FIG. 5 includes an area MC1 for setting and displaying the group goal and the user goals and an area MC2 for displaying progress statuses (achievement statuses) of the group goal and the user goals. The area MC1 includes a set button for selecting setting (registration) of the group goal and each of the user goals. However, the goal progress screen MC displayed at Step S1 (when the group goal and the user goals are not set) is such that a specific text (text “Trip to Okinawa” shown in FIG. 5) and a specific numeral (numeral “100,000 yen” shown in FIG. 5) or so for the group goal and the user goals are not displayed in the area MC1 and progress statuses (bar graphs and characters, etc. shown in FIG. 5) are not displayed in the area MC2.

To set a group goal, the user A operates the input device 112 to input Purpose, Desired amount of money, and Goal achievement period (including a savings start date and a savings end date) as the group goal in the area MC1. To set user goals of the member users, the user A operates the input device 112 to input a shared amount of money or a sharing rate of the user A and to input preset shared amounts of money or sharing rates of the rest of the member users (the user B and the user C in the present explanation) as the respective user goals of the member users in the area MC1. After the input of these data, the user A operates the input device 112 to press the set button.

When the set button is pressed, the setting unit 102a stores the purpose, the desired amount of money, and the goal achievement period input in the area MC1 as the group goal in the target-data storage unit 106b. When the set button is pressed, the setting unit 102a stores each of the shared amounts of money or of the sharing rates input in the area MC1, as the respective user goals of the member users, in the target-data storage unit 106b in association with the group goal.

Step S2: Summing of Remaining Amounts

When the check result is “they are stored”, the summing unit 102b reads the household accounts data for all the member users (the user B and the user C in the present explanation) except for the user A from the household-accounts data storage unit 106a. The summing unit 102b sums the remaining amounts of all the member users based on the read household accounts data for the user A, the user B, and the user C.

Step S3: Checking of Percent Complete

The checking unit 102c reads the group goal of a group in which the user A is included as a member user and the user goals of the member users (the user A, the user B, and the user C in the present explanation) of the group from the target-data storage unit 106b. The checking unit 102c calculates a percent complete (degree of achievement) of the group goal based on the read group goal and the sum of the remaining amounts calculated at Step S2. The checking unit 102c checks a percent complete (degree of achievement) of each of the user goals based on the read group goal and user goals of the member users and based on the household accounts data for the read member users (the user A, the user B, and the user C in the present explanation).

For example, the checking unit 102c may calculate a percent complete of the group goal based on Equation [“Sum of remaining amounts”÷“Desired amount included in group goal”]. In addition, for example, the checking unit 102c may calculate a percent complete of each of the user goals of the member users based on Equation [“Remaining amount included in household accounts data”÷“Shared amount included in the user goal”] or based on Equation [“Remaining amount included in household accounts data”÷(“Sharing rate included in user goal”×“Desired amount included in group goal”)]. It is determined that the greater the value calculated by Equation is, the higher the percent complete is.

The checking unit 102c may calculate forecast achievement dates of the group goal and each of the user goals. For example, on the assumption that all the member users continue to keep a present savings pace, the checking unit 102c may calculate a forecast achievement date of the group goal based on Equation [{(“Desired amount included in group goal”−“Sum of remaining amounts”)+(“Sum of remaining amounts”÷“Elapsed days from savings start date to present time included in goal achievement period”)}+Present date]. For example, on the assumption that each of the member users continues to keep a present savings pace as it is, the checking unit 102c may calculate a forecast achievement date of each user goal based on Equation [{(“Shared amount included in user goal”−“Remaining amount included in household accounts data”)+(“Remaining amount included in household accounts data”÷“Elapsed days from savings start date to present time included in goal achievement period”)}+Present date].

The checking unit 102c may also calculate each desired monthly amount of money in order to achieve the group goal and the user goals by the time of the savings end date (period) included in the goal achievement period. For example, the checking unit 102c may calculate a desired monthly amount of money for the group goal based on Equation [{(“Desired amount included in group goal”−“Sum of remaining amounts”)÷“Remaining days from present time to savings end date included in goal achievement period”}×30]. In addition, for example, the checking unit 102c may calculate a desired monthly amount of money for each user goal based on Equation [{(“Shared amount included in each user goal”−“Remaining amount included in household accounts data”)÷“Remaining days from present time to savings end date included in goal achievement period”}×30].

Step S4: Decision of Emotional Expressions of Characters

The deciding unit 102e decides emotional expressions of characters for which the emotional expressions are designed for the group goal and each of the user goals based on the percent complete of the group goal and the percent complete of each of the user goals, which are checked at Step S3.

For example, when a plurality of characters for which different emotional expressions (e.g., various emotions or mood states) are designed are previously prepared, and if a plurality of numerical ranges (thresholds) each associated with each character are previously set, the deciding unit 102e determines the one including a value of the percent complete from the numerical ranges, and decides a character associated with the numerical range determined that the value is included, as a character with an emotional expression according to the percent complete.

Step S5: Display of Screen on which Goals, Progresses, and Characters Appear

The progress-display executing unit 102d generates the goal progress screen MC shown in FIG. 5, and outputs the group goal and the user goals read at Step S3 to the area MC1 included in the generated goal progress screen MC.

The progress-display executing unit 102d outputs the sum of the remaining amounts calculated at Step S2 and the desired amount included in the group goal read at Step S3 to the position as shown in FIG. 5 in the area MC2 included in the goal progress screen MC in the form of graph (e.g., bar graph or circle graph) so that a difference between the sum and the desired amount is easily visible.

The progress-display executing unit 102d outputs the remaining amounts included in the household accounts data for the respective member users read at Step S2 and the shared amounts included in the user goals of the respective member users read at Step S3 to the positions as shown in FIG. 5 by each member user in the area MC2 included in the goal progress screen MC in the form of graph (e.g., bar graph or circle graph) so that a difference between each of the remaining amounts and each of the shared amounts is easily visible.

The progress-display executing unit 102d outputs the characters for which emotional expressions are decided at Step S4 (specifically, a character corresponding to the group and characters corresponding to the respective member users) to positions (e.g., the positions as shown in FIG. 5) in the area MC2 included in the goal progress screen MC so that each correspondence between the characters and the graphs output to the area MC2 is easily visible.

The progress-display executing unit 102d displays the goal progress screen MC after these outputs are performed on the monitor 114. Thus, the goal progress screen MC shown in FIG. 5 is displayed on the monitor 114.

3. Summary of Present Embodiment and Other Embodiments

As explained above, according to the present embodiment, the management of the household accounts book is implemented by setting a desired amount of money (e.g., a saving goal such that 500,000 yen will be saved from April to the end of the year for the purpose of traveling abroad at the end of the year) that a group (e.g., all the family members (users)) desires to save by a specific period, summing remaining amounts of the individuals of the members (a difference in balance between total income and total expenses), and managing a percent complete or a degree of achievement for the desired amount of the group. According to the present embodiment, a desired amount of money of each of the member users is set for the desired amount of the group to manage a percent complete or a degree of achievement for each of the desired amounts of the member users. In addition, according to the present embodiment, emotional expressions such as moods, gestures, and motions of the characters displayed on the household-accounts management application are changed according to the percent complete or the degree of achievement.

Therefore, in the management of the household accounts book, the goal for money (e.g., saving goal or savings goal) can be managed in terms of an overall group. As a result, it is possible to effectively prompt each of the member users to continue actions (e.g., money saving or savings, and utilization of a household accounts book) toward the achievement of the goal. Moreover, it is possible to set a group goal (saving goal) as the whole group and to set a user goal (shared goal or saving goal) of each of the member users with respect to the group goal. For the purpose (e.g., 200,000 yen is saved by the end of the year to go traveling) of a plurality of persons (e.g., all the family members), an allocation of the saving goal to each of the members is set, so that the progresses of the goals can be comprehensively managed.

Each of the member users can check the percent complete or the degree of achievement of the group goal of the whole group and of the user goal of the respective member users at that time while entering daily to his/her household accounts book. Moreover, each of the member users can check at a glance the statuses of the percent complete or the degree of achievement of the group goal and of the user goal of the respective member users from the states of emotional expressions of the characters displayed on the household-accounts management application. As a result of these features, each of the member users can be given a motivation or a pleasure for continuous utilization of the household accounts book (management of cash flows) and for promotion of saving.

Moreover, the present invention may be implemented in various different embodiments within the scope of technical idea described in the appended claims other than the embodiment.

For example, the case in which the desired money-amount management apparatus 100 performs processes in the form of stand-alone has been explained as one example. However, the desired money-amount management apparatus 100 may perform a process according to a request from a client terminal (a different apparatus from the desired money-amount management apparatus 100) and return the result of the process to the client terminal.

Of the processes explained in the embodiment, all or part of the processes explained as automatically performed ones can be manually performed, or all or part of the processes explained as manually performed ones can be also automatically performed using known methods.

In addition, the processing procedures, the control procedures, the specific names, the information including parameters such as registered data of the processes and search conditions, the screen examples, and the database configuration shown in the literatures and the drawings can be arbitrarily modified unless otherwise specified.

The components of the desired money-amount management apparatus 100 shown in the figures are functionally conceptual and therefore need not be physically configured as shown in the figures.

For example, for the process functions provided in the units of the desired money-amount management apparatus 100, especially for the process functions performed in the control unit 102, all or part thereof may be implemented by a CPU (central processing unit) and programs interpreted and executed in the CPU, or may be implemented by wired-logic hardware. The programs are recorded in a recording medium, explained later, and are mechanically read by the desired money-amount management apparatus 100 as required. More specifically, computer programs to give instructions to the CPU in cooperation with an OS (operating system) to perform various processes are recorded in the storage unit 106 such as ROM or a HDD (hard disk drive). The computer programs are executed by being loaded to RAM, and form the control unit in cooperation with the CPU.

The computer programs may be stored in an application program server connected to the desired money-amount management apparatus 100 via an arbitrary network, and all or part thereof can be downloaded as necessary.

The desired money-amount management program according to the present invention may be stored in a computer-readable recording medium, or can be configured as a program product. The “recording medium” mentioned here includes any “portable physical medium” such as a memory card, a USB (universal serial bus) memory, an SD (secure digital) card, a flexible disk, a magneto-optical disc, ROM, EPROM (erasable programmable read only memory), EEPROM (electronically erasable and programmable read only memory), CD-ROM (compact disk read only memory), MO (magneto-optical disk), DVD (digital versatile disk), and a Blu-ray Disc.

The “program” mentioned here is a data processing method described in an arbitrary language and a description method, and therefore any form such as a source code and a binary code is acceptable. The “program” is not necessarily limited to a program configured as a single unit, and, therefore, includes those dispersively configured as a plurality of modules and libraries and those in which the function of the program is achieved in cooperation with separate programs represented as OS (operating system). Any known configuration and procedures can be used as a specific configuration and a reading procedure to read a recording medium by the apparatus shown in the embodiments or as an installation procedure after the reading, or the like.

The various databases and the like (the household-accounts data storage unit 106a and the target-data storage unit 106b) stored in the storage unit 106 is a storage unit which is a memory device such as RAM and ROM, a fixed disk drive such as a hard disk, a flexible disk, and an optical disc, or the like. The storage unit 106 stores therein various programs, tables, databases, files for Web (World Wide Web) pages, and the like used to perform various processes and to provide Web sites.

The desired money-amount management apparatus 100 may be configured as an information processing apparatus such as known personal computer and work station, or may be configured by connecting an arbitrary peripheral device to the information processing apparatus. The desired money-amount management apparatus 100 may be provided by installing software (including the programs and the data, etc.) to cause the information processing apparatus to implement the desired money-amount management method according to the present invention.

Furthermore, a specific configuration of dispersion or integration of the apparatuses is not limited to the shown one. The apparatuses can be configured by functionally or physically dispersing or integrating all or part of the apparatuses in arbitrary units according to various types of additions or the like or according to functional loads. In other words, the embodiments may be implemented in arbitrary combinations thereof or an embodiment may be selectively implemented.

According to the present invention, it is configured to set a group goal for an amount of money for a group composed of a plurality of users registered in a household-accounts management application, to sum remaining amounts, registered in the household-accounts management application, of all member users being the users constituting the group, to check a progress status of the group goal based on the set group goal and the summed remaining amount, and to display the checked progress status on the display unit. Therefore, there is such an effect that in the management of the household accounts book, the goal for money (e.g., saving goal or savings goal) can be managed in terms of the overall group and this enables to effectively prompt each of the member users to continue actions (e.g., money saving or savings, and utilization of the household accounts book) toward the achievement of the goal.

According to the present invention, it is configured to set a user goal for an amount of money for a member user and to check a progress status of the user goal based on the set user goal for the member user and the remaining amount of the member user registered in the household-accounts management application. Therefore, there is such an effect that it is possible to more effectively prompt each of users constituting the group to continue actions (e.g., money saving or savings, and utilization of the household accounts book) toward the achievement of the goal.

According to the present invention, it is configured to decide an emotional expression of a character for which the emotional expression is designed based on the checked progress status and to display the character with the decided emotional expression on the display unit. Therefore, there is such an effect that it is possible to more effectively prompt each of users constituting the group to continue actions (e.g., money saving or savings, and utilization of the household accounts book) toward the achievement of the goal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A desired money-amount management apparatus comprising:
a control unit, and a display unit, wherein the control unit includes:
a setting unit that sets a group goal for an amount of money for a group composed of a plurality of users registered in a household-accounts management application;
a summing unit that sums remaining amounts, registered in the household-accounts management application, of all member users being the users constituting the group;
a checking unit that checks a progress status of the group goal based on the group goal set by the setting unit and the remaining amount summed by the summing unit; and
a progress-display executing unit that displays the progress status checked by the checking unit on the display unit.

2. The desired money-amount management apparatus according to claim 1, wherein
the setting unit sets a user goal for an amount of money for a member user, and
the checking unit checks the progress status of the user goal based on the user goal for the member user set by the setting unit and the remaining amount of the member user registered in the household-accounts management application.

3. The desired money-amount management apparatus according to claim 1, wherein
the control unit further includes a deciding unit that decides an emotional expression of a character, for which the emotional expression is designed, based on the progress status checked by the checking unit, and
the progress-display executing unit displays the character with the emotional expression decided by the deciding unit on the display unit.

4. A desired money-amount management method executed by a desired money-amount management apparatus including:
a control unit, and a display unit,
the method executed by the control unit comprising:
a setting step of setting a group goal for an amount of money for a group composed of a plurality of users registered in a household-accounts management application;
a summing step of summing remaining amounts, registered in the household-accounts management application, of all member users being the users constituting the group;
a checking step of checking a progress status of the group goal based on the group goal set at the setting step and the remaining amount summed at the summing step; and
a progress-display executing step of displaying the progress status checked at the checking step on the display unit.

5. A non-transitory computer-readable medium including programmed instructions for a desired money-amount management method executed by a desired money-amount management apparatus including: a control unit, and a display unit, wherein
the instructions, when executed by the control unit, cause the control unit to execute:
a setting step of setting a group goal for an amount of money for a group composed of a plurality of users registered in a household-accounts management application;
a summing step of summing remaining amounts, registered in the household-accounts management application, of all member users being the users constituting the group;
a checking step of checking a progress status of the group goal based on the group goal set at the setting step and the remaining amount summed at the summing step; and
a progress-display executing step of displaying the progress status checked at the checking step on the display unit.
